(19) United States
(12) Patent Application Publication
(10) Pub. No.: US 2026/0048949 A1
(43) Pub. Date: Feb. 19, 2026

(54) ITEM AUTOFEED SYSTEM

(71) Applicant: United States Postal Service, Washington, DC (US)

(72) Inventors: Wayne R. Perry-Eaton, Leesburg, VA (US); Everett McAdams, Annandale, VA (US)

(21) Appl. No.: 19/300,380

(22) Filed: Aug. 14, 2025

Related U.S. Application Data
(60) Provisional application No. 63/684,161, filed on Aug. 16, 2024.

(51) Int. Cl. B65G 47/91

(52) U.S. Cl. CPC B65G 47/914; B65G 2201/0258; B65G 2201/0285; B65G 2207/46

(57) ABSTRACT

A system may include a frame extending from a first position on an item process line to a second position on the item process line. The system may include a tray disposer connected to the frame, the tray disposer configured to receive a tray having a plurality of items therein and to position the tray at the first position. The system may include a lifting system comprising a vertical frame movably connected to the frame and an item securer movably connected to the vertical frame. The item securer may be configured to remove the plurality of items from the tray and secure the items prior to the items being moved, and after removing the plurality of items from the tray, move the plurality of items from the first position to the second position on the item process line.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Patent Application No. 63/684,161, filed Aug. 16, 2024, the contents of which are hereby incorporated by reference in their entirety.

### BACKGROUND

This application relates to automated processing of distribution items in a logistics network.

### SUMMARY

In some aspects, a system for moving items includes: a frame extending from a first position on an item process line to a second position on the item process line; a tray disposer connected to the frame, the tray disposer configured to receive a tray having a plurality of items therein and to position the tray at the first position; and a lifting system including: a vertical frame movably connected to the frame; and an item securer movably connected to the vertical frame and configured to: remove the plurality of items from the tray and secure the items prior to the items being moved; and after removing the plurality of items from the tray, move the plurality of items from the first position to the second position on the item process line.

In some embodiments, the item securer includes: a first paddle; a second paddle positioned opposite the first paddle; a shelf extending between the first paddle and the second paddle, wherein the first paddle, the second paddle, and the shelf define an opening configured to receive the items; and a blade movable between a first position in which the blade is positioned away from the opening, and a second position in which the blade is positioned to block the opening such that the items can be secured between the first paddle, the second paddle, the shelf.

In some embodiments, the shelf extends substantially perpendicular to the first paddle and the second paddle, and wherein the blade extends substantially parallel to the shelf when in the second position such that the first paddle, the second paddle, the shelf, and the blade define a substantially rectangular space within which the items can be secured.

In some embodiments, the item securer further includes a plate connected to the vertical frame, wherein the blade is configured to retract into the plate when in the first position and extend out from the plate when in the second position.

In some embodiments, the tray disposer includes: a horizontal support connected to the vertical frame; a first mitten connected to the horizontal support; and a second mitten connected to the horizontal support, wherein the second mitten is positioned opposite the first mitten such that the tray can be received between by the first mitten and the second mitten.

In some embodiments, the tray disposer further includes: a first plunger connected to the first mitten; and a second plunger connected to the second mitten; wherein the first mitten and the second mitten are each configured to move between a disengaged position in which the first plunger and/or the second plunger are positioned away from the tray, and an engaged position in which the first plunger and/or the second plunger are inserted through openings in the tray to engage the items in the tray.

In some embodiments, the system further includes a rotational movement device connected to the item securer and the tray disposer, the rotational movement device configured to rotate the item securer and the tray disposer relative to the frame.

In some embodiments, the rotational movement device is configured to rotate the item securer and the tray disposer about 180°.

In some embodiments, the tray disposer is further configured to remove the tray after the items have been removed from the tray.

In some embodiments, the tray disposer further includes a vacuum unit connected to the horizontal support, wherein the vacuum unit is configured to apply a suction force to the tray to secure the tray to the vacuum unit.

In some embodiments, the item securer includes: a first paddle; and a second paddle positioned opposite the first paddle; wherein the first paddle includes an opening configured to receive the first plunger, and wherein the second paddle includes an opening configured to receive the second plunger.

In some embodiments, the vertical frame is configured to move horizontally along the frame; and wherein the item securer is configured to move vertically along the vertical frame.

In some embodiments, a method for processing items includes: moving an item securer along a vertical frame towards the items, wherein the items are located at the first location and oriented in a first orientation; receiving the items into an opening of the item securer, moving the item securer containing the items along a frame; and depositing the items at the second location in the first orientation.

In some embodiments, the opening of the item securer is defined by a first paddle, a second paddle, and a shelf; and wherein the method further includes: moving a blade of the item securer to a position in which the blade blocks the opening; securing the items between the first paddle, the second paddle, the shelf, and the blade; moving the blade of the item securer away from the opening; and depositing the items from the opening at the second location.

In some embodiments, the method further includes: engaging, via a tray disposer, a tray containing the items; and lifting the tray by moving the tray disposer along the vertical frame towards the item securer.

In some embodiments, engaging, via the tray disposer, the tray includes inserting a first plunger and/or a second plunger of the tray disposer through openings in the tray to engage the items in the tray.

In some embodiments, the method further includes: rotating the item securer and the tray disposer from a first orientation to a second orientation; removing the tray from the items; and rotating the item securer and the tray disposer from the second orientation to the first orientation such that the items are aligned in the first orientation.

In some embodiments, the second orientation is about 180° relative to the first orientation such that the items are oriented substantially upside down when in the second orientation.

In some embodiments, the method further includes: moving the first paddle toward the second paddle to apply pressure to and secure the items between the first paddle and the second paddle.

In some embodiments, removing the tray from the items includes: engaging the tray with a vacuum unit; and moving the vacuum unit away from the items to move the tray off of the items.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1A depicts a schematic front view of an example embodiment of an item autofeed system.

FIG. 1B depicts a front isometric view of the autofeed system of FIG. 1A.

FIG. 1C depicts a front view of the autofeed system of FIG. 1A.

FIG. 2 shows a block diagram schematically illustrating various components of the autofeed system of FIGS. 1A-1C.

FIG. 3A depicts a state of the autofeed system during the process of removing and moving items.

FIG. 3B depicts a state of the autofeed system during the process of removing and moving items.

FIG. 3C depicts a state of the autofeed system during the process of removing and moving items.

FIG. 3D depicts a state of the autofeed system during the process of removing and moving items.

FIG. 3E depicts a state of the autofeed system during the process of removing and moving items.

FIG. 3F depicts a state of the autofeed system during the process of removing and moving items.

FIG. 3G depicts a state of the autofeed system during the process of removing and moving items.

FIG. 3H depicts a state of the autofeed system during the process of removing and moving items.

FIG. 3I depicts a state of the autofeed system during the process of removing and moving items.

FIG. 3J depicts a state of the autofeed system during the process of removing and moving items.

FIG. 3K depicts a state of the autofeed system during the process of removing and moving items.

FIG. 3L depicts a state of the autofeed system during the process of removing and moving items.

FIG. 3M depicts a state of the autofeed system during the process of removing and moving items.

FIG. 3N depicts a state of the autofeed system during the process of removing and moving items.

### DETAILED DESCRIPTION

In the following detailed description, reference is made to the accompanying drawings. In the drawings, similar symbols typically identify similar components, unless context dictates otherwise. Thus, in some embodiments, part numbers may be used for similar components in multiple figures, or part numbers may vary from figure to figure. The illustrative embodiments described herein are not meant to be limiting. Other embodiments may be utilized, and other changes may be made, without departing from the spirit or scope of the subject matter presented. It will be readily understood that the aspects of the present disclosure and illustrated in the figures, can be arranged, substituted, combined, and designed in a wide variety of different configurations by a person of ordinary skill in the art, all of which are made part of this disclosure.

Described herein are automated systems and methods that unload distribution items from a tray and load then into item processing equipment. The United States Postal Service (USPS) delivers approximately 129 billion pieces of mail to approximately 163 million delivery points throughout the United States. The USPS uses sophisticated sorting systems that quickly and efficiently scans incoming mail and determines the delivery location of each mail item. Proper alignment and orientation of distribution items can ensure proper handling and accurate scanning in automated processing equipment. If the distribution items are not aligned properly, it can lead to a delay in the delivery of distribution items or lead to delivery to incorrect address. After items have been properly aligned and oriented, they must still be transported to a sorting system configured to sort the distribution items by location or by another characteristic.

Manual methods for transporting distribution items are slow and inefficient but are effective at ensuring the distribution items maintain the proper alignment and orientation. Automatic methods for transporting distribution items are quicker and more efficient than manual methods, however the distributions items are often jostled or disturbed such that the proper alignment and orientation is not maintained. Described herein are systems and methods for transporting items while maintaining a certain orientation or alignment of the distributions items.

In particular, the autofeed systems and methods described herein receive items, such as letters, packages, flats, magazines, or other distribution items, in a tray. In some embodiments, the items are transported to the system via a conveyor. The autofeed system includes a lifting system that removes the items from the tray, removes the tray, and then places the items in a location where the items can further be processed. The lifting system may include a rotational movement device to rotate the items to an advantageous orientation such that the items do not fall out or become jostled during transport. The lifting system may further include an item securer configured to apply pressure to the items to further prevent them from becoming jostled or misaligned during transport, thus maintaining the proper orientation and alignment of the items.

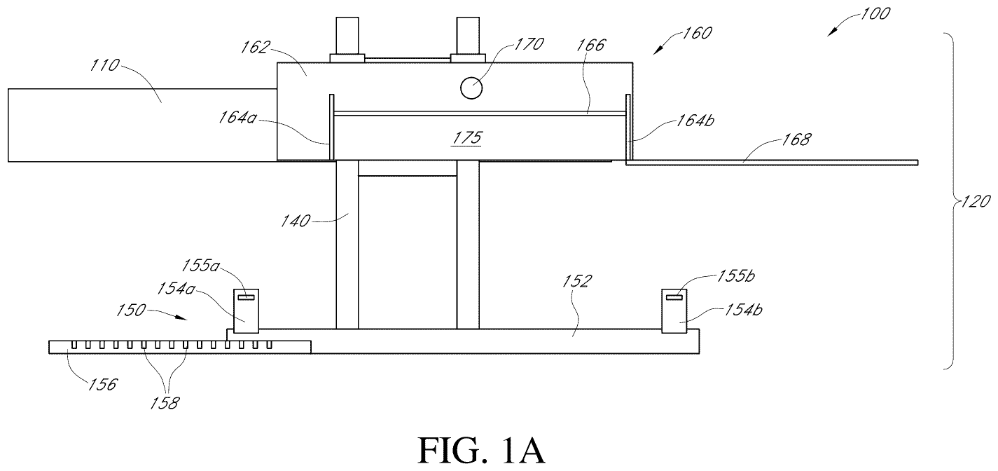

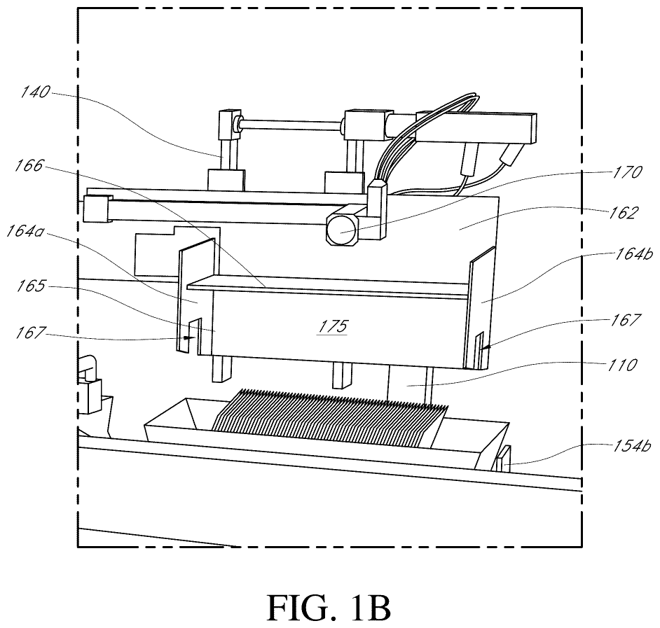

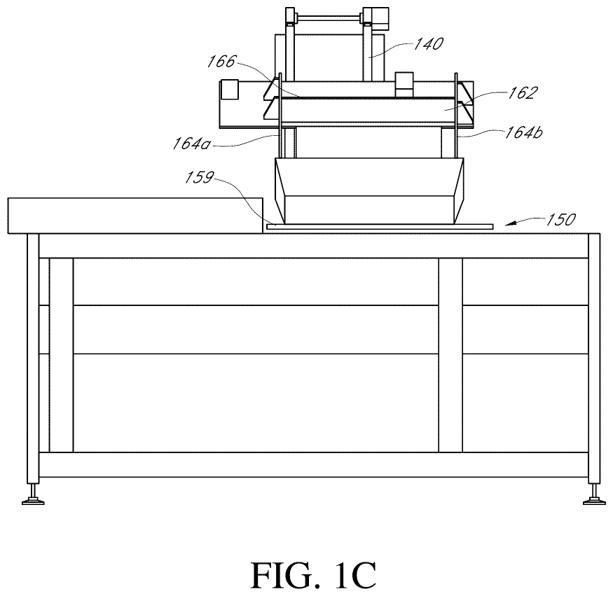

FIG. 1A is a schematic front view of an autofeed system 100. As seen in FIG. 1A, the autofeed system 100 includes a frame 110 and a lifting system 120. The frame 110 extends from a first end of the autofeed system to a second end of the autofeed system 100. In some embodiments, the frame 110 is composed of a metal or a plastic. In some embodiments, the frame 110 is composed of a composite material. In some embodiments, the frame 110 includes tracks or ruts that run along the length the frame 110 to facilitate the movement of the lifting system 120 along the length of the frame 110. In some embodiments, the frame 110 includes at least one rail that runs the length of the frame 110 to facilitate movement of the lifting system 120 along the length of the frame 110.

The lifting system 120 is configured to receive items (e.g., one or more items) and to convey them to a different location. In some embodiments, the lifting system 120 is configured to transport items which may be distribution items, such as articles of mail. The articles of mail may include items of various size and shape, such as letters, flats, packages, magazines, catalogs, flats, and parcels. In some embodiments, items are conveyed to the lifting system 120 within a tray.

The lifting system 120 includes a vertical frame 140, a tray disposer 150, an item securer 160, and a rotational movement device 170. In some embodiments, the lifting system 120 may be orientated at about a 15° angle back along a rotational axis that is parallel to the length of the frame 110. Such an orientation may beneficially prevent items being transported by the lifting system 120 from falling out while moving along the length of the frame 110.

The vertical frame 140 extends from a top portion of the autofeed system 600 to a bottom portion of the autofeed system 600. The vertical frame 140 is movably connected to the frame 110 and is configured to move along the length of the frame 110. The vertical frame 140 can move horizontally along the frame 110. In some embodiments, the vertical frame 140 is connected to the frame by means of a movement device, which may include motors, wheels or other devices for moving along the frame 110. In some embodiments, the vertical frame 140 is configured to engage with a rail, track or rut of the frame 110 and move along the length of the vertical frame. In some embodiments, the vertical frame 140 includes at least one rail, track or rut to facilitate vertical movement of the tray disposer 150 and/or the item securer 160 along the length of the vertical frame 140. The item securer 160 and/or the tray disposer 150 can move vertically along the vertical frame 140. In some embodiments, the vertical frame 140 serves to movably secure the item securer 160 and the tray disposer 150 to the frame 110 such that the item securer 160 and tray disposer 150 can move horizontally along the length of the frame 110 by means of the vertical frame 140.

The tray disposer 150 is attached to the vertical frame 140. In some embodiments, the tray disposer 150 may be attached to the vertical frame 140 near a bottom portion of the vertical frame 140. In some embodiments, the tray disposer 150 is movably connected to the vertical frame 140 by means of a movement device. The movement device may include motors, wheels or other devices for moving along the vertical frame 140. In some embodiments, the tray disposer 150 is configured to move vertically along the length of the vertical frame 140. In some embodiments, the tray disposer 150 is configured to rotate from a position behind the vertical frame 140 or from a position adjacent to the vertical frame 140 to a position where the tray disposer 150 can interact with a tray. In some embodiments, the tray disposer 150 slides out from a position behind the vertical frame 140 or adjacent to the vertical frame 140 until it reaches a position where the tray disposer 150 can interact with a tray. In some embodiments, once a tray has arrived at or near the autofeed system 100, the tray disposer 150 is configured to slide out from behind the vertical frame 140 or slide out from a position adjacent to the vertical frame 140 such that the tray disposer 150 positions itself below a tray.

In some embodiments, the tray disposer 150 includes a horizontal support 152, a first and second mittens 154a and 154b, and a vacuum unit 156. The horizontal support 152 is connected to the vertical frame 110. In some embodiments, the horizontal support 152 includes the movement device and is configured to engage with the rail, track or rut of the vertical frame 140, thereby permitting the tray disposer 150 to vertically move along the height of the vertical frame 140. The horizontal support 152 may be substantially rectangular in shape. In some embodiments, the horizontal support 152 is of a length that is longer than that of a tray. In some embodiments, the horizontal support 152 has a length that is about 1× (1 times), or about 1.5×, or about 2× the length of a tray.

As seen in FIG. 1A, the first and second mittens 154a and 154b may be rotatably connected to the horizontal support 152. As seen in FIG. 1A, the first mitten 154a may be connected to the horizontal support 152 near a first end of the horizontal support 152 and the second mitten 154b may be connected to the horizontal support 152 near a second end of the horizontal support 152. The mittens 154a and 154b are configured to rotate from a disengaged position (as seen in FIG. 1A) to an engaged position (as seen in FIG. 1B). In some embodiments, the first and second mittens 154a and 154b are not configured to rotate. In some embodiments, only one of the mittens 154a and 154b are configured to rotate.

The mittens 154a and 154b include a first and second plungers 155a and 155b. In some embodiments, the plungers 155a and 155b are rectangular in shape. In some embodiments, the plungers 155a and 155b are composed of a metal or a plastic. In some embodiments, the plungers 155a and 155b are composed of a composite material. In some embodiments, the plungers 155a and 155b are attached to the mittens 154a and 154b at a top portion of the mittens 154a and 154b. A first plunger 155a is attached to the first mitten 154a and a second plunger 155b is attached to the second mitten 154b. In some embodiments, the plungers 155a and 155b may be stored within the mittens 154a and 154b and are configured to extend outward from the mittens 154a and 154b.

When the mittens 154a and 154b are moved or rotated from the disengaged position to the engaged position, the plungers 155a and 155b are configured to be inserted through openings located on a first and second end on a tray and exert a force on the items contained within in the tray. In some embodiments, when the mittens 154a and 154b are rotated from the disengaged position to the engaged position, the plungers 155a and 155b may extend over a top portion of a tray and engage with the items contained within the tray. When in the disengaged position, the first plunger 155a and/or the second plunger 155b can be positioned away from the tray or tray openings.

When a tray containing items arrives at the autofeed system 100, the tray disposer 150 is configured to interact with the tray. In some embodiments, the mittens 154a and 154b rotate from a disengaged position to an engaged position and the plungers 155a and 155b are inserted through openings of the tray and exert a force on the items in the tray, thereby securing the items in the tray and maintaining the items in a certain orientation. In some embodiments, the plungers 155a and 155b exert a force on the items in the tray such that the items in the tray are maintained in a substantially upright position. In some embodiments, after the mittens 154a and 154b have rotated to the engaged position, the plungers 155a and 155b are configured to extend out from within the mittens 154a and 154b and engage with the items in the tray. In some embodiments one mitten 154a or 154b is not configured to rotate and is permanently in the engaged position. In this configuration, once a tray has arrived at the autofeed system 600 the other mitten 154a or 154b rotates from the disengaged position to an engaged position. Once the tray and the items within the tray have been secured by the tray disposer 150, the tray disposer is configured to move vertically along the vertical frame 140, thereby lifting the tray towards the item securer.

In some embodiments, the tray disposer includes a vacuum unit 156. In some embodiments, the vacuum unit 156 may be separate from the auto feed system 100. In some embodiments, the vacuum unit 156 is connected to the horizontal support 152. The vacuum unit 156 is connected to the horizontal support 152 at a position that is below the first and second mittens 154a and 154b. In some embodiments, the vacuum unit 156 may be configured to rotate between a first and second position. The first position may be a position where the vacuum unit 156 can engage with a tray. The second position may be located away from the autofeed system 100 where the vacuum unit 156 can drop or deposit an empty tray.

In some embodiments, the vacuum unit 156 comprises at least one vacuum channel 158. In some embodiments, the vacuum channels 158 are located along the length of the vacuum unit 156. The vacuum channels 158 are configured to exert a suction force sufficient to secure a tray to the vacuum unit 156. In some embodiments, when the vacuum unit 156 rotates to the first position and is ready to engage with a tray, the vacuum channels 158 may exert a suction force which secures the tray to the vacuum unit 156. Once the tray has been secured to the vacuum unit 156, the vacuum unit 156 may rotate to the second position, where the vacuum channels 158 may stop exerting a suction force, thereby allowing the tray to fall or drop off of the vacuum unit.

In some embodiments, the tray disposer 150 includes a mechanical arm. In some embodiments, the mechanical arm takes the place of the vacuum unit 156. The mechanical arm is configured to engage with a tray and remove the tray from the autofeed system once the items have been removed from the tray.

Once items have been removed from a tray via the item securer 160, the vacuum unit 156 or mechanical arm engages with the tray and rotates from the first position to the second position. Once the vacuum unit 156 or mechanical arm has rotated to the second position, the vacuum unit 156 or mechanical arm releases the tray, thereby dropping or placing the tray away from the autofeed system 100.

The item securer 160 is attached to the vertical frame 140. In some embodiments, the tray disposer 150 is attached to the vertical frame 140 near a top portion of the vertical frame 140. In some embodiments, the item securer 160 is movably connected to the vertical frame 140 by means of a movement device. The movement device may include motors, wheels or other devices for moving along the vertical frame 140. In some embodiments, the item securer 160 is configured to move vertically along the length of the vertical frame 140.

The item securer 160 includes a plate 162, a first and second paddles 164a and 164b, a shelf 166, and a blade 168. As seen in FIG. 1A, the plate 162 may be connected to the vertical frame 140 at a location higher than that of the horizontal support 152. The plate 162 may be substantially rectangular in shape. The length of the plate 162 may be longer than that of a tray. In some embodiments, the length of the plate 162 may be about 1× (1 times), or about 1.5×, or about 2× the length of a tray. The height of the plate 162 may be substantially similar to that of the tray. In some embodiments, the height of the plate 162 may be more than that of the tray. In some embodiments, the height of the plate 162 may be about 1× (1 times), or about 1.5×, or about 2× the height of the tray.

As seen in FIG. 1A, the paddles 164a and 164b are connected to the plate 162. The first paddle 164a is connected to a first location of the plate 162. In some embodiments, the first location is a first end of the plate 162. In some embodiments, the first location is proximate a central location along the length of the plate 162. In some embodiments, the first paddle 164a is stationary. In some embodiments, the first paddle 164a is configured to move along the length of the plate 162.

The second paddle 164b is connected to the plate 162 at a second position. In some embodiments, the second position is a second end of the plate 162. In some embodiments, the second paddle 164b is configured to move between a second location of the plate 162 and the first location of the plate 162.

In some embodiments, both of the paddles 164a and 164b may be stationary. In some embodiments, the first and second paddles 164a and 164b may have a width that is less than the width of the top of a tray, thereby permitting the paddles 164a and 164b to be inserted into the tray without contacting a side of a tray. In some embodiments, the first and second paddles 164a and 164b may have a width that is substantially similar to that of the bottom of a tray. In some embodiments, the height of the first and second paddles 164a and 164b is greater than that of a tray. In some embodiments, the height of the paddles 164a and 164b are approximately 1× (1 times), or 1.5×, or 2× the height of the tray 104.

The shelf 166 is connected to the plate 162. In some embodiments, the shelf 166 is connected to the plate 162 above the paddles 164a and 164b. In some embodiments, the shelf 166 is connected the plate 162 and to the paddles 164a and 164b. In some embodiments, the shelf 166 is only connected to the paddles 164a and 164b. As shown in FIG. 1A, the shelf 166 can extend substantially perpendicular to the first paddle 164a and the second paddle 164b.

In some embodiments, the shelf 166 includes two pieces. A first piece of the shelf 166 may be connected to the first paddle 164a and a second piece of the shelf 166 may be connected to the second paddle 164b. In some embodiments, the first piece of the shelf 166 is connected to the plate 162 for additional stability. In some embodiments, the first piece of the shelf 166 may be hollow and configured to allow the second piece of the shelf 166 to slide in and out of the hollow first piece of the shelf 166. In some embodiments, the second piece of the shelf 166 is positioned at a vertical position slightly higher or slightly lower than the first piece of the shelf 166 allowing the second piece of the shelf 166 to slide past the first piece of the shelf 166.

In some embodiments, the shelf 166 may be formed of a single piece. In some embodiments, the second paddle 164b is configured to move along the shelf 166 between the first location and the second position of the plate 162. In some embodiments, the second paddle 164b comprises an opening that accommodates the shelf 166 thereby allowing the second paddle 164b to move along the shelf 166. The width of the shelf 166 may be substantially similar to that of the first and second paddles 113.

After the tray disposer 150 has secured a tray and the items within the tray and/or lifted the tray towards the item securer 160, the item securer 160 is configured to descend along the vertical frame 140 towards the tray. The first paddle 164a, the second paddle 164b, and the shelf 166 can define an opening 175 configured to the receive the items contained in the tray. The item securer 160 continues to descend until the paddles 164a and 164b are positioned on either side of the items in the tray. In some embodiments, the paddles 164a and 164b include gaps that accommodate the plungers 155a and 155b, thereby allowing the paddles 164a and 164b to move past the plungers 155a and 155b. Once the paddles 164a and 164b are positioned on either side of the items, the second paddle 164b moves towards the first paddle 164a and exerts a pressure on the items, thereby securing the items between the paddles 164a and 164b. In some embodiments, the first and second paddles 164a and 164b may move towards each other, thereby exerting a pressure on the items. Once a sufficient pressure has been applied to the items by the paddles 164a and 164b, the item securer 160 is configured to move up along the vertical frame 140 a certain distance.

The blade 168 may be connected to the plate 162 at a location that is beneath the first and second paddles 164a and 164b. In some embodiments, the blade 168 is connected to a bottom side of the plate 162. In some embodiments, the blade 168 is orientated such that it is substantially parallel with the shelf 166. In some embodiments, the blade 168 may be configured to rotate between a first and second position. The first position may be a position where the blade 168 points away from the plate 162 (as seen in FIG. 1A). The second position may be a position such that the shelf 166, the first and second paddles 164a and 164b and the blade 115 form four walls, thereby creating a rectangular shape that can be used to secure items within the rectangular shape formed. In some embodiments, the blade 168 may be configured to move vertically to accommodate items of a larger size. In some embodiments, the blade 168 is of a length that approximately the distance between the first paddle 164a and the second end of the plate 162. In some embodiments, the blade 168 is of a width substantially similar to that of the shelf 166.

In some embodiments, the blade 168 is slidably connected to the plate 162. In some embodiments, the blade 168 is connected to a bottom surface of the plate 162 and is configured to move out from below the plate 162. In some embodiments, the blade 168 is contained within the plate 162 and is configured to move or extend out from the plate 162. In this configuration, the blade 168 is configured to move between a first and second position by retracting into and extending out of the plate 162. In the first position, the blade 168 is located beneath or within the plate 162. In the second position, the blade 168 can be positioned to block the opening 175 such the items can be secured between the first paddle 164a, the second paddle 164b, the shelf 166, and the blade 168. In the second position, the shelf 166, the first and second paddles 164a and 164b and the blade 168 effectively form a rectangular shape or space. In some embodiments, the blade 168 is extendable. In a non-extended position, the blade 168 is located underneath or within the plate 162. In an extended position, at least a portion of the blade 168 extends outward such that the shelf 166, the first and second paddles 164a and 164b and the blade 168 effectively form a rectangle to hold items.

The blade 168 is configured to rotate or move from the first position to the second position once the tray has been removed by the tray disposer 150, thereby further securing the items held by the item securer 160.

The auto feed system 100 also includes a rotational movement device 170. The rotation movement device 170 is configured to rotate the item securer 160 and/or the tray disposer 150. The rotational movement device 170 is connected the item securer 160 and/or the tray disposer 150 and is configured to rotate the item securer 160 and the tray disposer 150 along a rotational axis normal to the plate 162 of the item securer 160. In some embodiments, the rotational movement device 170 may be configured to rotate the item securer 160 and the tray disposer 150 up to 180° along a rotational axis normal to the item securer 160. In some embodiments, the rotational movement device 170 may be configured to rotate the item securer 160 and the tray disposer 150 between 120° and 150°. In some embodiments, the rotational movement device 170 may be connected to the vertical frame 140 and be configured to rotate the vertical frame 140 with the item securer 160 and the tray disposer 150. The rotational movement device 170 can include a rotary motor or any other mechanism for enabling rotational motion.

Once a tray disposer 150 has been secured the tray with the mittens 154a and 154b and the item securer 160 has descended and secured the items within the tray by means of the paddles 164a and 164b, the rotational movement device 170 is configured to rotate the item securer 160 and the tray disposer 150. In some embodiments, the rotation movement device 170 rotates the item securer 160 and the tray disposer 150 between about 120° and about 150°. This beneficially prevents the items from falling out of the item securer 160 while the tray is being removed.

FIG. 1B shows a front isometric view of the autofeed system 100 of FIG. 1A. As seen in FIG. 1B, only a top portion of the first and second paddles 164a and 164b are secured to the plate 162. In some embodiments, there may be a gap 165 in between a bottom portion of the first and second paddles 164a and 164b and the plate 162. The gap 165 may be of a width slightly wider than that of a side of a tray, thereby allowing the side of the tray to slide between the first and second paddles 164a and 164b and the plate 162. Additionally, the first and second paddles 164a and 164b may each comprise an opening 167 at the bottom of the first and second paddles 164a and 164b. In some embodiments, the openings 167 may be centrally located along the width of the first and second paddles 164a and 164b and may have a width that is smaller than the width of the first and second paddles 164a and 164b. In some embodiments, the width of the openings may be substantially similar to that of the first and second plungers 155a and 155b, thereby accommodating the first and second plungers 155a and 155b when the first and second paddles 164a and 164b are inserted into the tray. Additionally in some embodiments, the openings 167 may extend from the bottom of the first and second paddles 164a and 164b to about half the height of the first and second paddles 164a and 164b. In some embodiments, the openings 167 extend less than half the height of the first and second paddles 164a and 164b.

As seen in FIG. 1B, in some embodiments, the autofeed system 100 may not include a tray disposer 150. In some embodiments, the tray disposer 150 is not connected to the vertical frame 140. In some embodiments, the tray disposer 150 is movably connected to the frame 110.

FIG. 1C shows a front view of the autofeed system 100 of FIG. 1A. As seen in FIG. 1C, the tray disposer 150 includes a support plate 159. In some embodiments, the tray disposer 150 is configured to rotate from a position behind the vertical frame 140 to a position where the tray disposer 150 can interact with the tray. In some embodiments, the tray disposer 150 slides out from a position behind the vertical frame 140 until it reaches a position where the tray disposer 150 can interact with the tray. In the embodiment show in FIG. 1C, the support plate 159 is inserted under the tray. After being inserted under the tray, the support plate 159 may lift the tray and items contained in the tray.

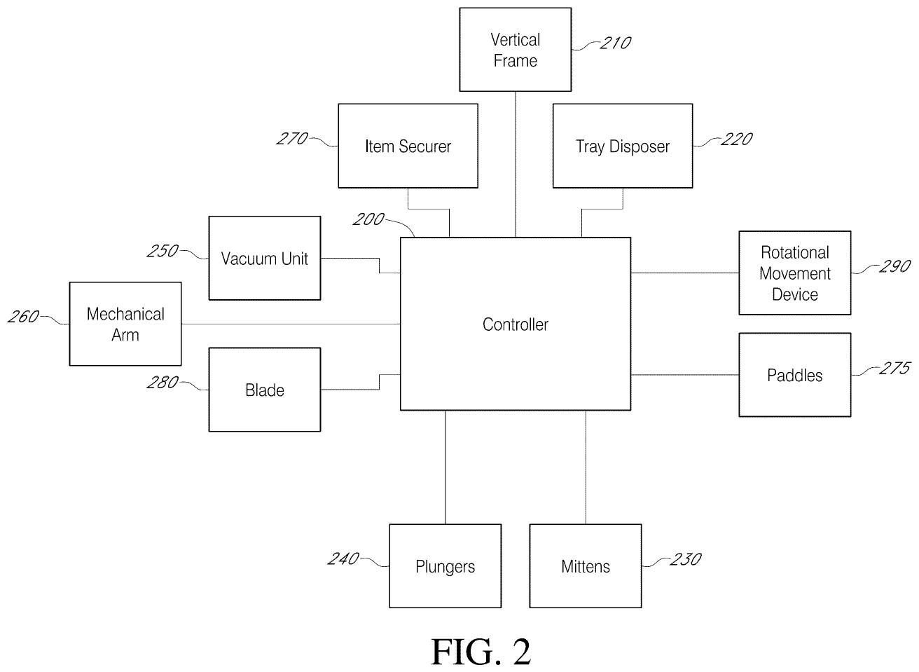

FIG. 2 is a block diagram schematically illustrating various components of the autofeed system 100 of FIGS. 1A-1C. The autofeed system 100 includes a controller 200 which can be used in autonomously controlling the operation of the autofeed system 100. The controller 200 may include one or more processors, integrated circuits, field-programmable gate array or any other suitable control circuitry. In one embodiment, the controller 200 includes a Raspberry Pi system. In some embodiments, the controller 200 may include one or more transceivers able to communicate via Bluetooth, Wi-Fi, or any other suitable local area communication protocol with local devices, such as a user device. In some embodiments, the controller 200 includes one or more transceivers able to communicate via 4G, 5G, Edge or any other suitable wide area communication protocol with external devices, including remote devices such as cloud servers or other network entities.

The controller 200 is in communication with various components of the autofeed system 100, including a vertical frame 210, such as the vertical frame 140 as described above. The communication between the controller 200 and the vertical frame 210 may be wired or wireless. The controller 200 may send a signal to the vertical frame 210 to command the vertical frame 210 to move horizontally along the length of the frame 110. A change in state of the vertical frame 210 may be commanded in response to a user command or a local device.

In some embodiments, in response to a signal received from the controller 200, the vertical frame 210 may move from a first position along the along the length of the frame 110 to a second position along the length of the frame 110 or from the second position to the first position. In some embodiments, the first position may be a location where the autofeed system 100 can receive a tray with items. In some embodiments, the second position may be a location where the autofeed system 100 can deposit items that were received from a tray. In some embodiments, the vertical frame 210 may include one or more sensors to determine when the vertical frame 210 has arrived at the first or second position.

The controller 200 is in communication with a tray disposer 220 of the autofeed system 100, such as the tray disposer 150 described above. The communication between the controller 200 and the tray disposer 220 may be wired or wireless. The controller 200 may send a signal to the tray disposer 220 to command the tray disposer 220 to move vertically along the length of the vertical frame 210. In some embodiments, the controller 200 may send a signal to the tray disposer 220 to command the tray disposer 220 to rotate between a first position and a second position. In some embodiments, the controller 200 may send a signal to the tray disposer 220 to command the tray disposer 220 to slide and/or move between a first position and a second position. A change in state of the tray disposer 220 may be commanded in response to a user command or a local device.

In some embodiments, in response to a signal received from the controller 200, the tray disposer 220 may move from a first position along the along the height of the vertical frame 210 to a second position along the height of the vertical frame 210 or from the second position to the first position. In some embodiments, the first position may be a location where the tray disposer 220 can interact with a tray. In some embodiments, the second position may be a location above and/or below the first position. In some embodiments, when the tray disposer 220 is in the second position, the tray disposer 150 is clear of a tray.

In some embodiments, in response to a signal received from the controller 200, the tray disposer 220 may rotate from a first position to a second position or from the second position to the first position. In some embodiments, the first position may be a location where the tray disposer 220 can interact with a tray. In some embodiments, the second position may be a location above and/or below the first position. In some embodiments, the second position may be behind or to the side of the first position.

In some embodiments, in response to a signal received from the controller 200, the tray disposer 220 may slide from a first position to a second position or from the second position to the first position. In some embodiments, the first position may be a location where the tray disposer 220 can interact with a tray. In some embodiments, the second position may be a location above or below the first position. In some embodiments, the second position may be behind or to the side of the first position.

The controller 200 is in communication with one or mittens 230, such as the first and second mittens 154a and 154b. The communication between the controller 200 and the mittens 230 may be wired or wireless. The controller 200 may send a signal to the mittens 230 to command the one or more of the mittens 230 to rotate between a disengaged position to an engaged position. A change in state of the mittens 230 may be commanded in response to a user command or a local device.

In some embodiments, in response to a signal received from the controller 200, the mittens 230 may rotate from a disengaged position to an engaged position. In some embodiments, the disengaged position may be a position where the one or more mittens 230 are rotated away from a tray. In some embodiments, the engaged position may be a location where the mittens 230 contact or are able to interact with a tray. In some embodiments, only one of the mittens 230 may rotate in response to a signal received from the controller 200. In some embodiments, the mittens 230 and/or the autofeed system 100 may include one or more sensors to determine when mittens 230 are in the disengaged position or in the engaged position. In some embodiments, the autofeed system 100 includes one or more sensors to determine when a tray has arrived at the autofeed system 100.

The controller 200 is in communication with one or more plungers 240, such as the first and second plungers 155a and 155b. The communication between the controller 200 and the plungers 240 may be wired or wireless. The controller 200 may send a signal to the plungers 240 to command the one or more of the plungers 240 to slide or to extend from a stored configuration to an extended configuration. A change in state of the plungers 240 may be commanded in response to a user command or a local device.

In some embodiments, in response to a signal received from the controller 200, the plungers 240 may extend or slide from a stored configuration to an extended configuration. In some embodiments, in the stored configuration, the plungers 240 may be stored or contained within the mittens 230. In some embodiments, in the extended position, the plungers 240 may extended out from the mittens 230 such that the plungers can interact with items within a tray. In some embodiments, only one of the plungers 240 may slide or extend in response to a signal received from the controller 200. In some embodiments, the plungers 240 and/or the autofeed system 100 may include one or more sensors to determine when the plungers 240 are in the stored configuration or in the extended configuration.

The controller 200 is in communication with a vacuum unit 250, such as the vacuum unit 156 described above. The communication between the controller 200 and the vacuum unit 250 may be wired or wireless. The controller 200 may send a signal to the vacuum unit 250 to command the vacuum unit 250 to rotate or move between a first position and a second position. In some embodiments, the controller 200 may send a signal to the vacuum unit 250 to command one or more vacuum channels, such as the vacuum channels 158 described above, on the vacuum unit 250 to exert a suction force or to cease exerting a suction force. A change in state of the vacuum unit 250 or vacuum channels may be commanded in response to a user command or a local device.

In some embodiments, in response to a signal received from the controller 200, the vacuum unit 250 may rotate or move between a first position to a second position. In some embodiments, the first position may be a location where the vacuum unit 250 can interact with a tray. In some embodiments, the second position may be a location away from the autofeed system 100, such that a tray can be safely dropped. the first position. In some embodiments, in response to a signal received from the controller 200, one or more vacuum channels on the vacuum unit 250 may exert a suction force on a tray or other object, thereby securing the tray to the vacuum unit 250. In some embodiments, in response to a signal received from the controller 200, one or more vacuum channels on the vacuum unit 250 may cease exerting a suction force on a tray or other object, thereby allowing the tray or other object to fall off the vacuum unit 250.

The controller 200 is in communication with a mechanical arm 260, such as the mechanical arm described above. The communication between the controller 200 and the mechanical arm 260 may be wired or wireless. The controller 200 may send a signal to the mechanical arm 260 to command the mechanical arm 260 to rotate or move between a first position and a second position. In some embodiments, the controller 200 may send a signal to the mechanical arm 260 to command the mechanical arm 260 to secure or release a tray or other object. A change in state of the mechanical arm 260 may be commanded in response to a user command or a local device.

In some embodiments, in response to a signal received from the controller 200, the mechanical arm 260 may rotate or move between a first position to a second position. In some embodiments, the first position may be a location where the mechanical arm 260 can interact with a tray. In some embodiments, the second position may be a location away from the autofeed system 100, such that a tray can be safely dropped by the mechanical arm 260. In some embodiments, in response to a signal received from the controller 200, the mechanical arm 260 may secure a tray. In some embodiments, in response to a signal received from the controller 200, the mechanical arm 260 may release a tray, thereby allowing the tray to drop.

The controller 200 is also in communication with an item securer 270, such as the item securer 160 described above. The communication between the controller 200 and the item securer 270 may be wired or wireless. The controller 200 may send a signal to the item securer 270 to command the item securer 270 to move vertically along the length of the vertical frame 140. A change in state of the item securer 270 may be commanded in response to a user command or a local device.

In some embodiments, in response to a signal received from the controller 200, the item securer 270 may move from a first position along the along the height of the vertical frame 140 to a second position along the height of the vertical frame 140. In some embodiments, the first position may be a location where the item securer 270 can interact with a tray held by the tray disposer 220. In some embodiments, the second position may be a location above the first position. In some embodiments, when the item securer 270 is in the second position, the item securer 270 is clear of a tray held by the tray disposer 220. In some embodiments, the item securer 270 may include one or more sensors to determine when the item securer 270 has arrived at the first or second position.

The controller 200 is also in communication with one or more paddles 275 of the item securer 270, such as the first and second paddles 164a and 164b described above. The communication between the controller 200 and the paddles 275 may be wired or wireless. The controller 200 may send a signal to the paddles 275 to command the paddles to move or slide along a plate of the item securer 270. A change in state of the paddles 275 may be commanded in response to a user command or a local device.

In some embodiments, in response to a signal received from the controller 200, one or more paddles 275 may move along the plate or along a shelf of the item securer 270 as described above. In some embodiments, in response to a signal received from the controller 200 a first paddle 275 may move towards a second paddle 275 until a sufficient force is applied to items located between the paddles 275 such that the items are secured between the paddles 275. In some embodiments, in response to a signal received from the controller 200, both paddles 275 may move towards each other until a sufficient pressure is applied to items located between the paddles 275 such that the items are secured between the paddles 275. In some embodiments, the paddles 275 and/or autofeed system 100 may include one or more sensors to determine when a sufficient pressure has been applied to the items.

The controller 200 is also in communication with a blade 280, such as the blade 168 described above. The communication between the controller 200 and the blade 280 may be wired or wireless. The controller 200 may send a signal to the blade 280 to command the blade 280 to rotate or move between a first position and a second position. In some embodiments, the controller 200 may send a signal to the blade 280 to command the blade 280 slide out from a plate between an extended position and a non-extended position. A change in the state of the blade 280 may be commanded in response to a user command or a local device.

In some embodiments, in response to a signal received from the controller 200, the blade 280 may rotate or move between a first position to a second position. In some embodiments, the first position may be a location where the blade 280 forms a rectangular shape with the paddles 275 and a shelf. In some embodiments, the second position may be a location away from the autofeed system 100. In some embodiments, in response to a signal received from the controller 200, the blade 280 may slide or extend between an extended position and a non-extended position. In some embodiments, the extended position may be a position where the blade 280 forms a rectangular shape with the paddles 275 and a shelf. In some embodiments, the non-extended position may be a position where the blade 280 is located within or substantially within a plate. In some embodiments, the blade 280 and/or autofeed system may include one or more sensors to determine when a blade is in the first position or the second position or when the blade is in the extended position or the non-extended position.

As can be seen in FIG. 2, the controller 200 is also in communication with a rotational movement device 290, such as the rotation movement device 170 described above. The communication between the controller 200 and the rotational movement device 290 may be wired or wireless. The controller 200 may send a signal to the rotational movement device 290 to command the rotational movement device 290 to rotate the item securer 270 and/or the tray disposer 220 along a rotational axis normal to a plate of the item securer 270. A change in state of the rotational movement device 290 may be commanded in response to a user command or a local device.

In some embodiments, in response to a signal received from the controller 200, the rotational movement device 290 may rotate the item securer 270 and/or the tray disposer 220. In some embodiments, in response to a signal received from the controller 200, the rotational movement device 290 may be configured to rotate the item securer 270 and/or the tray disposer 220 up to 180° along a rotational axis normal to a plate of the item securer 160. In some embodiments, in response to a signal received from the controller 200, the rotational movement device 290 may be configured to rotate the item securer 270 and/or the tray disposer 220 between 120° and 150°. In some embodiments, the rotational movement device 290 may be connected to the vertical frame 210 and, in response to a signal received from the controller 200, be configured to rotate the vertical frame 210 with the item securer 270 and the tray disposer 220.

The controller 200 can be configured to automatically perform some or all of the processes described herein. In some embodiments, the controller 200 may be configured to perform some processes automatically, and then wait for additional input before proceeding to other processes described herein. In some embodiments, the autofeed system 100 comprises one or more sensors configured to detect trays, items, etc. at various locations within the system 100. The controller 200 is in communication with the sensors, and the controller 200 instructs various components of the autofeed system 100 in response to information received from the sensors. For example, the process for processing items described herein begins automatically when the controller senses a tray of distribution items on the tray disposer 150 or the support plate 159. The sensor may be a weight sensor in the tray disposer 150 to detect the tray, or may be an optical sensor configured to detect the presence of the tray through video, a beam break, or other similar sensor. In some embodiments, a conveyor which conveys the tray to the system 100 may have a sensor therein and may provide information to the controller 200 about the presence of the tray on they conveyor in the correct position for processing. Once the tray is detected by one or more of the sensors, the controller 200 instructs the various components of the autofeed system 100 to process the tray and items as described herein.

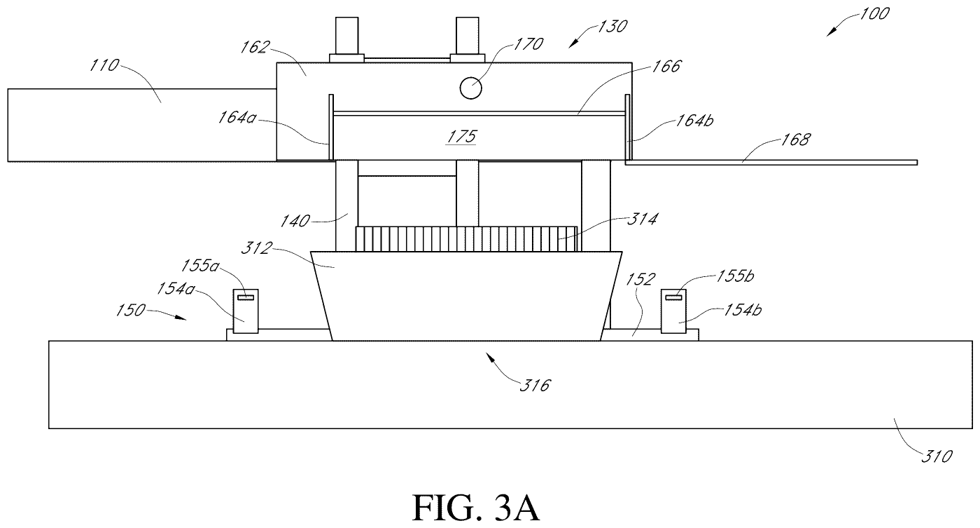

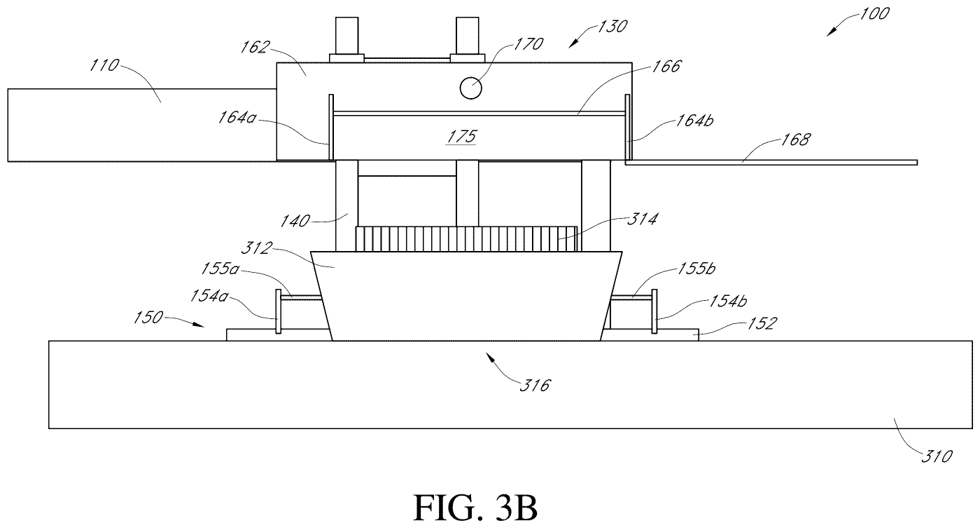

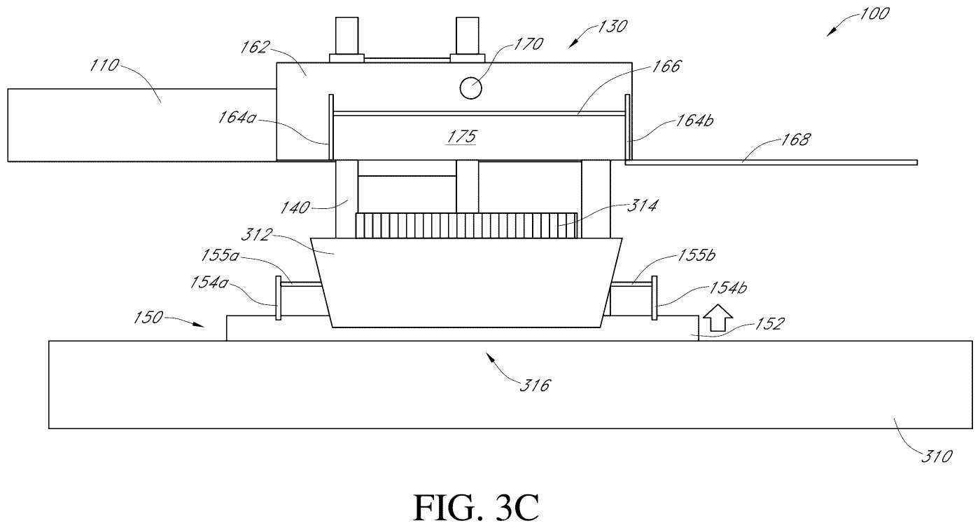

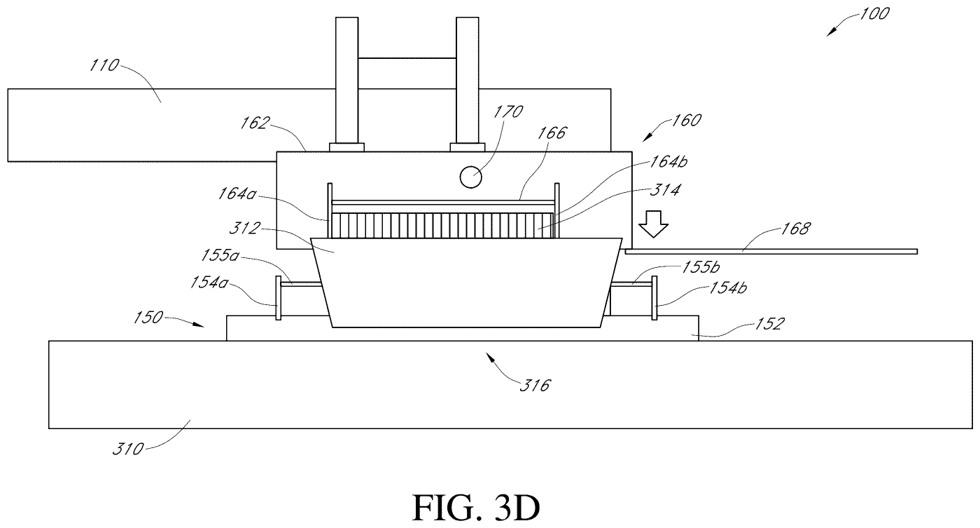

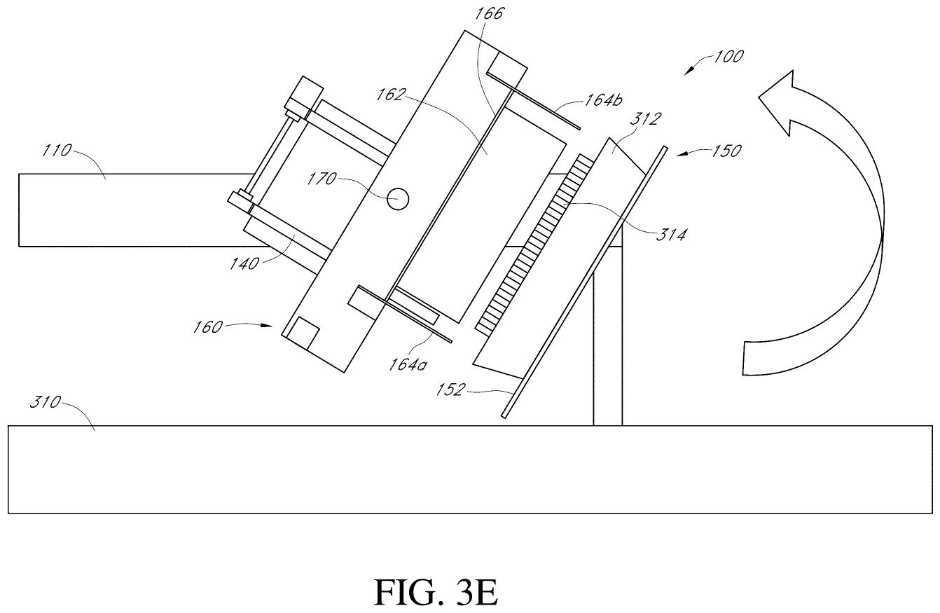

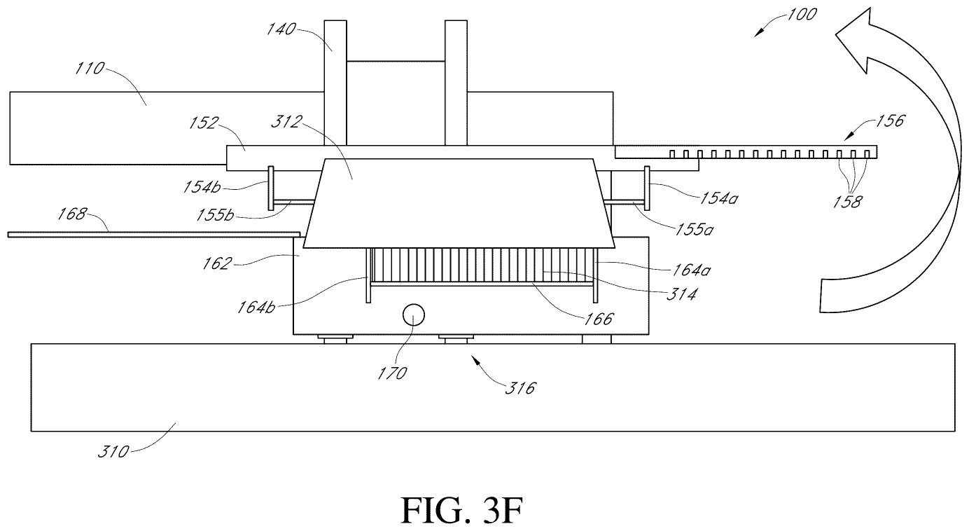

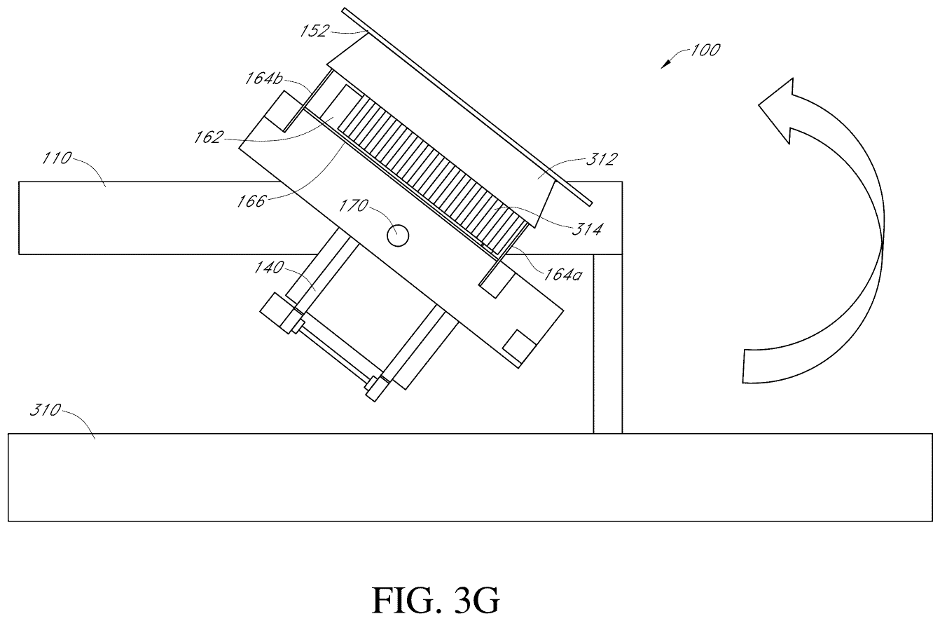

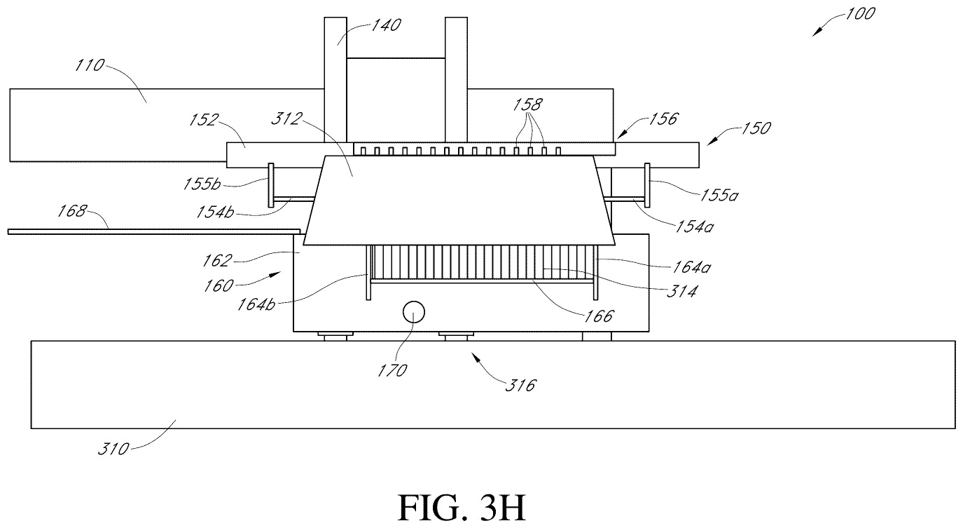

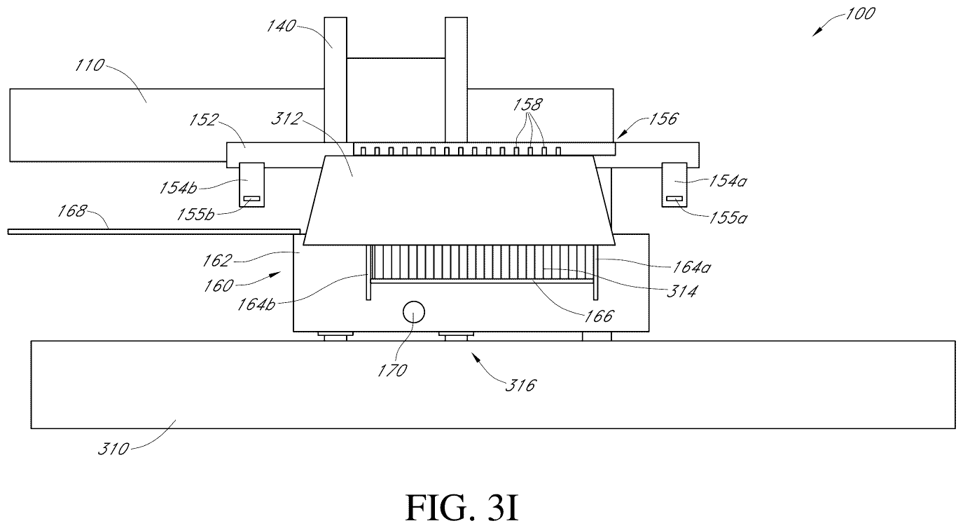

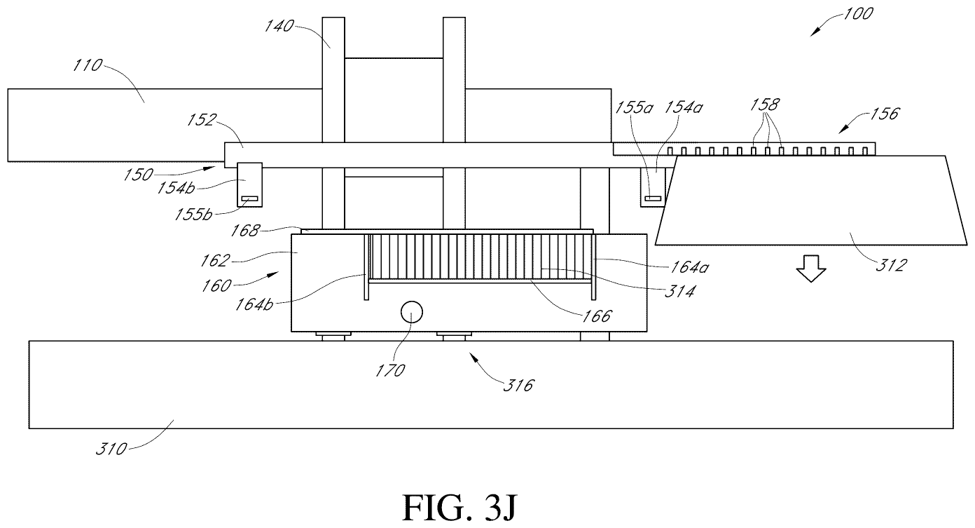

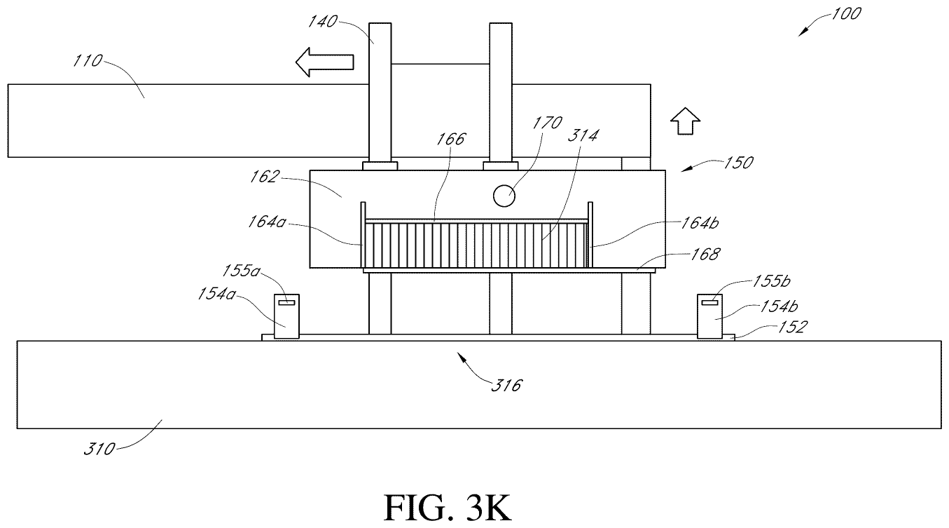

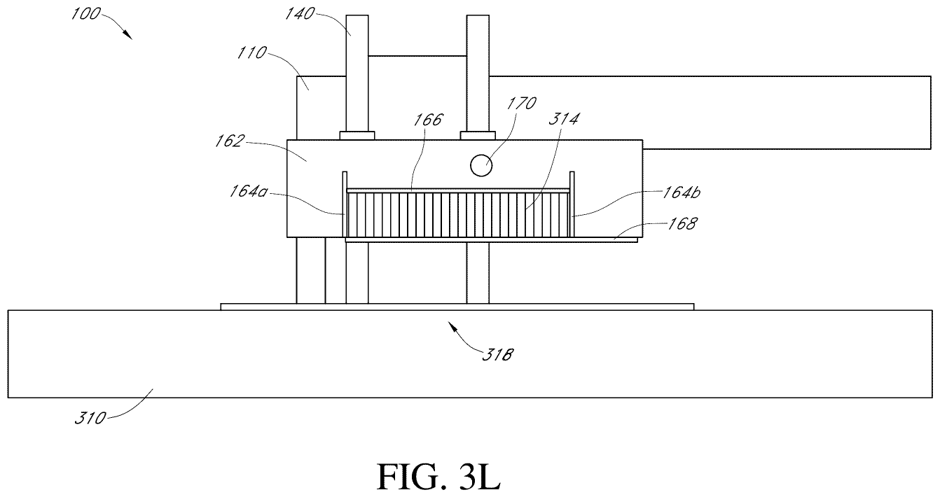

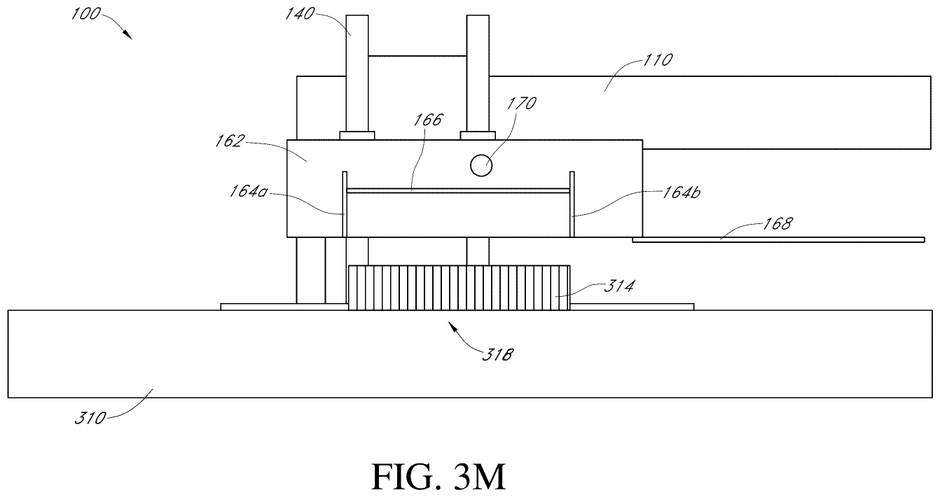

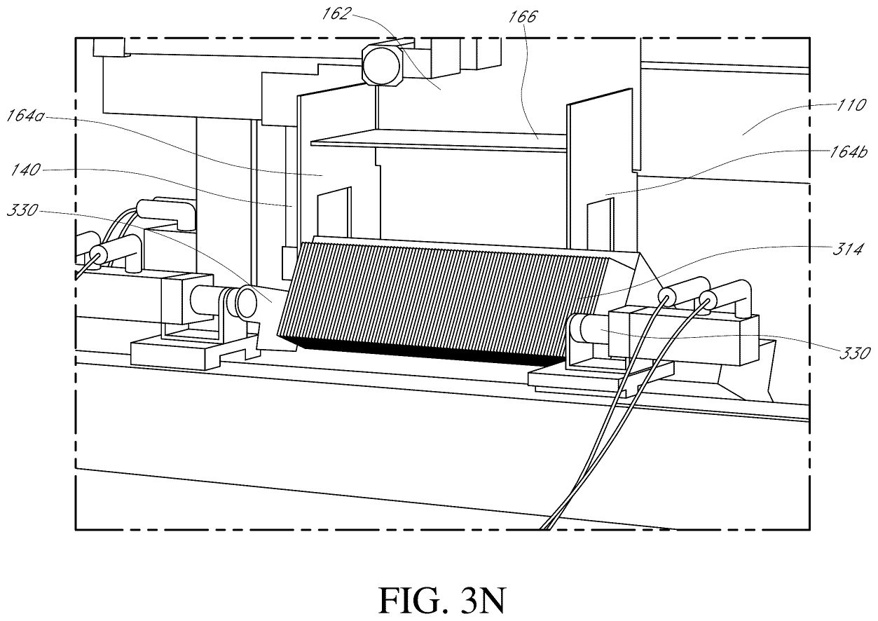

FIGS. 3A-3N depict states of an autofeed system 100 throughout a method for moving items from one location to another based on the embodiments described within.

FIG. 3A depicts a tray 312 containing items 314 at a first location 316 along a conveyor 310. In some embodiments, the tray 312 was transported to the first location 316 by the conveyor 310. In some embodiments, the first location 316 is a location proximate to the autofeed system 100 such that the autofeed system 100 can interact with the tray 312. Prior to the tray 312 arriving at the first location 316, one or more of the first and second mittens 154a and 154b may be in a disengaged position as seen in FIG. 3A, thereby allowing the tray 312 to arrive at the first location 316 without being inhibited by the first and second mittens 154a and 154b.

In some embodiments, once the tray 312 has arrived at the first location 316, via the conveyor 310, the tray disposer 150 slides out, rotates out or extends out from a position behind the vertical frame 140 of the autofeed system 100 until it reaches a position where the tray disposer 150 can interact with the tray 312. In some embodiments, the tray disposer 150 is configured to slide out from behind the vertical frame 140 such that the support plate 159 of the tray disposer 150 is positioned below the tray 312 and above the conveyor 310, thereby supporting the tray 312 for moving vertically with the tray disposer 150. In some embodiments, the tray 312 may be placed in the first location 316 by a robotic arm or an operator, or some other system, and there may be no conveyor 310 delivering trays 312 to the first location 316.

FIG. 3B depicts the first and second mittens 154a and 154b rotated from a disengaged position to an engaged position such that the first and second mittens 154a and 154b interact with the tray 312. In some embodiments, the items 314 may be aligned in a first orientation in the tray 312. In some embodiments, Upon the first and second mittens 154a and 154b rotating to the engaged position, the first and second plungers 155a and 155b are inserted through openings on each end of the tray 312 and engage with the items 314 contained in the tray 312, thereby pushing the items 314 to a central position of the tray 312 and maintaining the items 314 in the upright position. This configuration beneficially allows the autofeed system 100 to support the items 314 while lifting the tray 312.

FIG. 3C depicts the tray disposer 150 lifting the tray 312 and items 314. After the first and second mittens 154a and 154b have engaged the tray 312, the tray disposer 150 is configured to lift the tray 312 off the conveyor 310 by moving vertically along the length of the vertical frame 140. In some embodiments, the tray disposer 150 is configured to vertically lift the tray 312 and items 314 a certain height above the conveyor 310. In some embodiments, the height may be sufficient to allow the tray 312 to be rotated without contacting the conveyor 310.

FIG. 3D depicts the item securer 160 moving vertically along the height of the vertical frame 140 to a position where the item securer 160 can interact with the items 314 in the tray 312 and securing the items 314 in the tray 312. After the tray disposer 150 has lifted the tray 312 off of the conveyor 310 to a certain height above the conveyor 310. The item securer 160 moves vertically towards the items 314. The item securer 160 moves in a downward direction until the first and second paddles 164a and 164b are located on either side of the items 314 in the tray 312. In some embodiments, the item securer 160 may move in the downward direction until the paddles 164a and 164b touch the bottom of the tray 312. After the item securer 160 has moved such that the paddles 164a and 164b are located on either side of the items 314 in the tray 312, the first paddle 164a and/or the second paddle 164b may move horizontally towards the items 314, thereby exerting a pressure on the items 314 in the tray 312 until the items 314 are secured by the first and second paddles 164a and 164b.

FIG. 3E depicts the rotational movement device 170 rotating the item securer 160 and the tray disposer 150 relative to the frame 110. The rotational movement device 170 can rotate the item securer 160 and the tray disposer 150 between at least a first orientation and a second orientation. The first and second orientations of the item securer 160 and the tray disposer 150 can be the same as or correspond to the first and second orientations of the items contained within the item securer 160. In some embodiments, the rotational movement device 170 rotates the item securer 160 and/or the tray disposer up to 90° such that the items 314 slide or fall against one of the paddles 164a or 164b. In some embodiments, rotational movement device 170 rotates the item securer 160 and/or the tray disposer about 15°. In some embodiments, the rotational movement takes place before the first paddle 164a and/or second paddle 164b moves horizontally to exert pressure on the items 314 in the tray 312 thereby securing the items 314. Once the items have slid or fallen against the first paddle 164a or second paddle 164b, the opposite paddle may move and exert a pressure on the other side of the items 314 thereby securing the items between the paddles 164a and 164b. In some embodiments, the rotational movement occurs after the item securer 160 has secured the items 314.

FIG. 3F depicts the rotational movement device 170 rotating the item securer 160 and the tray disposer 150 up to 180° relative to the frame 110. After the items 314 in the tray 312 have been secured by the paddles 164a and 164b, the rotational movement device 170 is configured to rotate the item securer 160 and the tray disposer 150 up to 180° such that the tray 312 is now oriented upside down or mostly upside down relative to its previous position. In some embodiments, the rotational movement device 170 rotates the item securer 160 and the tray disposer 150 between 120° and 150° as seen in FIG. 3G. The rotation of the item securer 160 and the tray disposer 150 beneficially prevents the items 314 from falling out of the tray 312 when the tray 312 is removed. In some embodiments, the autofeed system 100 may also be configured to rotate approximately 15° away from the conveyor 310 along a rotational axis that is parallel to the length of the frame 107. In this configuration, the items 314 in the tray 312 are less likely to fall out towards the conveyor 310.

FIG. 3H depicts the mechanical arm or vacuum unit 156 of the tray disposer 150 rotating to a position where the mechanical arm or vacuum unit 156 can interact with the tray 312. After the tray 312 has been rotated via the rotational movement of the item securer 160 and the tray disposer 150, the vacuum unit 156 or mechanical arm rotates or slides from the first position to the second position proximate the tray 312. In the second position, the vacuum unit 156 is positioned proximate the rotated tray 312 such that the vacuum unit 156 can engage with the tray 312. Upon rotating to the second position, the vacuum channels 158 of the vacuum unit 156 apply a suction force to the tray 312, thereby securing the tray 312 to the vacuum unit 156. This beneficially prepares the tray 312 for being removed from the items 314.

FIG. 3I depicts the first and second mittens 154a and 154b disengaging from the tray 312 and rotating from the engaged position to the disengaged position. This beneficially allows the tray 312 to be removed from the items 314.

FIG. 3J depicts the tray 312 being removed from the items 314. Upon the first and second mittens 154a and 154b disengaging from the tray 312, the vacuum unit 156 is configured to lift the tray 312 off of the items 314 and then rotate or slide from the second position to the first position. In some embodiments, the tray disposer 150 is configured to move in the upward direction, thereby causing the vacuum unit 216 and the tray 312 to be lifted off the items 314. In some embodiments, the item securer 160 is configured to move in the downward direction, thereby causing the items 314 to move away from the tray 312. In some embodiments, the tray disposer 150 may move upward and the item securer 160 may move downward. Upon arriving at the first position, the vacuum unit 156 is configured to release the tray 312.

After the tray 312 has been removed from the items 314 or the items 314 have been moved away from the tray 312, the blade 168 rotates, slides or extends from a first position to a second position proximate the items 314. When the blade 168 is in the second position, the blade 168, the shelf 166, and the paddles 164a and 164b form a rectangular shape that the items 314 are contained within. This beneficially prevents the items 314 from falling out upon the item securer 160 being rotated back to its initial position.

FIG. 3K depicts the item securer 160 and the tray disposer 150 being rotated back to their initial orientation by the rotational movement device 170. After the blade 168 has rotated into the second position, the rotational movement device 170 is configured to rotate the item securer 160 and the tray disposer 150 back to their initial orientations. This beneficially allows the items 314 secured by the item securer 160 to be moved and deposited at a different location.

FIG. 3L depicts the items 314 being moved along the frame 110. After the item securer 160 has rotated back to the initial orientation, the vertical frame 140 may transport the item securer 160 along with the items 314 to a second location 318 further down the process line.

FIG. 3M depicts the items 314 being deposited at the second location 318. After the item securer 160 arrives at the second location 318 further down the process line, the blade 168 is configured to rotate, slide or collapse from the second position to the first position. After the blade 168 moves to the first position, the first paddle 164a and/or second paddle 164b may be configured to move horizontally away from the items 314 such that the pressure applied to the items 314 is alleviated, thereby allowing the items 314 to fall out of the item securer 160 or to be placed at the current location (e.g., the second location 318). In some embodiments, the items 105 are released in such a manner that the items 314 continue to be aligned in a first orientation. After depositing (e.g., dropping) the items 314, the vertical frame 140 may be configured to return to the first location 316 on the process line and await a new tray carrying items.

In some embodiments, as seen in FIG. 3N, there may be additional processing equipment located at the second location 318. The autofeed system 100 may be configured to drop or place the items 314 in or on the additional processing equipment. The additional processing equipment may include paddles, conveyors, or other features configured to receive the items 314. In some embodiments, reception paddles 320 may be present at the second location 318. The reception paddles 320 may be configured to receive the items 314 from the item securer 160. The reception paddles 320 may be further configured to maintain the orientation of the items 314 as they were in the item securer 160 and then push or direct the items 314 to another part of the process. In some embodiments, the equipment may comprise a shaker or agitator to ensure all the items are aligned against or in contact with one or more surfaces.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. A system for moving items, the system comprising:
a frame extending from a first position on an item process line to a second position on the item process line;
a tray disposer connected to the frame, the tray disposer configured to receive a tray having a plurality of items therein and to position the tray at the first position; and
a lifting system comprising:
a vertical frame movably connected to the frame; and
an item securer movably connected to the vertical frame and configured to:
remove the plurality of items from the tray and secure the items prior to the items being moved; and
after removing the plurality of items from the tray, move the plurality of items from the first position to the second position on the item process line.

2. The system of claim 1, wherein the item securer comprises:
a first paddle;
a second paddle positioned opposite the first paddle;
a shelf extending between the first paddle and the second paddle, wherein the first paddle, the second paddle, and the shelf define an opening configured to receive the items; and
a blade movable between a first position in which the blade is positioned away from the opening, and a second position in which the blade is positioned to block the opening such that the items can be secured between the first paddle, the second paddle, the shelf.

3. The system of claim 2, wherein the shelf extends substantially perpendicular to the first paddle and the second paddle, and wherein the blade extends substantially parallel to the shelf when in the second position such that the first paddle, the second paddle, the shelf, and the blade define a substantially rectangular space within which the items can be secured.

4. The system of claim 2, wherein the item securer further comprises a plate connected to the vertical frame, wherein the blade is configured to retract into the plate when in the first position and extend out from the plate when in the second position.

5. The system of claim 1, wherein the tray disposer comprises:
a horizontal support connected to the vertical frame;
a first mitten connected to the horizontal support; and
a second mitten connected to the horizontal support, wherein the second mitten is positioned opposite the first mitten such that the tray can be received between by the first mitten and the second mitten.

6. The system of claim 5, wherein the tray disposer further comprises:
a first plunger connected to the first mitten; and
a second plunger connected to the second mitten;
wherein the first mitten and the second mitten are each configured to move between a disengaged position in which the first plunger and/or the second plunger are positioned away from the tray, and an engaged position in which the first plunger and/or the second plunger are inserted through openings in the tray to engage the items in the tray.

7. The system of claim 5, wherein the system further comprises a rotational movement device connected to the item securer and the tray disposer, the rotational movement device configured to rotate the item securer and the tray disposer relative to the frame.

8. The system of claim 7, wherein the rotational movement device is configured to rotate the item securer and the tray disposer about 180°.

9. The system of claim 7, wherein the tray disposer is further configured to remove the tray after the items have been removed from the tray.

10. The system of claim 9, wherein the tray disposer further comprises a vacuum unit connected to the horizontal support, wherein the vacuum unit is configured to apply a suction force to the tray to secure the tray to the vacuum unit.

11. The system of claim 6, wherein the item securer comprises:
a first paddle; and
a second paddle positioned opposite the first paddle;
wherein the first paddle comprises an opening configured to receive the first plunger, and wherein the second paddle comprises an opening configured to receive the second plunger.

12. The system of claim 1, wherein the vertical frame is configured to move horizontally along the frame; and wherein the item securer is configured to move vertically along the vertical frame.

13. A method for processing items, the method comprising:
moving an item securer along a vertical frame towards the items, wherein the items are located at a first location and oriented in a first orientation;
receiving the items into an opening of the item securer,
moving the item securer containing the items along a frame; and
depositing the items at a second location in the first orientation.

14. The method of claim 13, wherein the opening of the item securer is defined by a first paddle, a second paddle, and a shelf; and wherein the method further comprises:
moving a blade of the item securer to a position in which the blade blocks the opening;
securing the items between the first paddle, the second paddle, the shelf, and the blade;
moving the blade of the item securer away from the opening; and
depositing the items from the opening at the second location.

15. The method of claim 13, further comprising:
engaging, via a tray disposer, a tray containing the items; and
lifting the tray by moving the tray disposer along the vertical frame towards the item securer.

16. The method of claim 15, wherein engaging, via the tray disposer, the tray comprises inserting a first plunger and/or a second plunger of the tray disposer through openings in the tray to engage the items in the tray.

17. The method of claim 15, further comprising:
rotating the item securer and the tray disposer from a first orientation to a second orientation;
removing the tray from the items; and
rotating the item securer and the tray disposer from the second orientation to the first orientation such that the items are aligned in the first orientation.

18. The method of claim 17, wherein the second orientation is about 180° relative to the first orientation such that the items are oriented substantially upside down when in the second orientation.

19. The method of claim 14, further comprising moving the first paddle toward the second paddle to apply pressure to and secure the items between the first paddle and the second paddle.

20. The method of claim 17, wherein removing the tray from the items comprises:
engaging the tray with a vacuum unit; and
moving the vacuum unit away from the items to move the tray off of the items.
